(19) United States
(12) Patent Application Publication
(10) Pub. No.: US 2024/0067818 A1
(43) Pub. Date: Feb. 29, 2024

(54) RESIN COMPOSITION AND MOLDED BODY

(71) Applicant: SUMITOMO CHEMICAL COMPANY, LIMITED, Tokyo (JP)

(72) Inventors: Yuta KIKUCHI, Chiba (JP); Shintaro SAITO, Ibaraki (JP); Kensuke MAEKAWA, Osaka (JP)

(21) Appl. No.: 18/262,306

(22) PCT Filed: Feb. 1, 2022
(86) PCT No.: PCT/JP2022/003773

§ 371 Date: Jul. 20, 2023

(30) Foreign Application Priority Data
Feb. 1, 2021 (JP) 2021-014344

(51) Int. Cl. C08L 67/04; C08K 7/14

(52) U.S. Cl. CPC C08L 67/04; C08K 7/14; C08L 2205/12

(57) ABSTRACT

A resin composition including a liquid crystalline polymer and a fluororesin, wherein the fluororesin has a peak area percentage of a CF₃ groups content relative to a CF₂ groups content in the fluororesin of 0.05% or more, as determined by the following [Method for measuring CF₃ groups content]: the CF₃ groups content relative to the CF₂ groups content in the fluororesin is calculated as an area percentage from a peak area ICF₃ corresponding to the CF₃ groups and a peak area ICF₂ corresponding to the CF₂ groups measured by ¹⁹F solid-state NMR, and is determined by the following formula (f1): CF₃ groups content (%)={(ICF₃/3)/(ICF₂/2)}×100 (f1).

### TECHNICAL FIELD

The present invention relates to a resin composition and a molded body.

The present application claims priority to Japanese Patent Application No. 2021-014344 filed in Japan on Feb. 1, 2021, the content of which is incorporated herein by reference.

### BACKGROUND ART

Polymer materials is used in various fields because they are easily molded and lightweight. In particular, in recent years, high performance polymer materials (engineering materials), which can be a substitute for metal or ceramics, have been used in a wide variety of fields including electrical, electronic, mechanical, optical device, automobile, aircraft and medical fields.

Among them, in the field of electrical and electronic components, further miniaturization of those components is underway in the trend of reduction of weight, thinning and compacting. Furthermore, those components tend to be required to have higher performance such as thermal stability suitable for surface mounting technology using lead-free soldering.

From the viewpoint of satisfying these requirements, liquid crystalline polymers are particularly excellent materials among the engineering materials mentioned above. Liquid crystalline polymers have good moldability such as thin wall fluidity and low occurrence of burr, have high thermal stability, high mechanical strength and excellent insulation properties, and are highly flame retardant without use of highly environmentally harmful additives.

As a resin composition comprising a liquid crystalline polymer, for example, Patent Literature 1 discloses a liquid crystalline polyester resin composition in the form of pellets, at least comprising 100 parts by weight of a liquid crystalline polyester resin and 10 to 100 parts by weight of glass fiber, wherein the glass fiber has a weight average fiber length of 30 to 100 μm and the composition comprises 0.1 to 5.0% by weight of a glass fiber having a fiber length of 300 to 500 μm based on the total amount of glass fiber.

### CITATION LIST

### Patent Literature

Patent Literature 1: International Publication No. WO 2012/090410

### SUMMARY OF INVENTION

### Problems to be Solved by Invention

However, occurrence of die swell may be a problem in conventional resin compositions described in Patent Literature 1. Die swell is a phenomenon in which molten resin expands after exiting the extrusion molding die. When die swell occurs, the resulting pellets have a non-uniform particle size, which reduces productivity.

The present invention has been made in view of such circumstances and an object of the present invention is to provide a resin composition with good effects of suppressing occurrence of die swell and a molded body prepared using the resin composition.

### Means to Solve the Problems

To solve the above problem, the present invention employs the following configuration.

[1] A resin composition comprising a liquid crystalline polymer and a fluororesin, wherein the fluororesin has a peak area percentage of a CF₃ groups content relative to a CF₂ groups content in the fluororesin of 0.05% or more, as determined by the following [Method for measuring CF₃ groups content]:

[Method for Measuring CF₃ Groups Content]:
the CF₃ groups content relative to the CF₂ groups content in the fluororesin is calculated as an area percentage from a peak area ICF₃ corresponding to the CF₃ groups and a peak area ICF₂ corresponding to the CF₂ groups measured by ¹⁹F solid-state NMR, and is determined by the following formula (f1):

CF₃ groups content (%)={(ICF₃)/3/(ICF₂)/2}×100 (f1)

[2] The resin composition according to [1], further comprising a glass fiber.

[3] The resin composition according to [1] or [2], further comprising a plate filler.

[4] The resin composition according to any one of [1] to [3], wherein the fluororesin has an decomposition starting temperature of resin of 473° C. or higher.

[5] A molded body prepared by using the resin composition according to any one of [1] to [4].

### Effects of Invention

The present invention can provide a resin composition with good effects of suppressing occurrence of die swell and a molded body prepared using the resin composition.

### BRIEF DESCRIPTION OF DRAWING

FIG. 1 is a schematic view showing a bobbin for a coil of the present embodiment.

### EMBODIMENTS FOR CARRYING OUT INVENTION

(Resin Composition)

The resin composition of the present embodiment comprises a liquid crystalline polymer and a fluororesin.

<Liquid Crystalline Polymer>

The liquid crystalline polymer in the resin composition of the present embodiment is a thermoplastic resin that exhibits liquid crystal-like properties in which linear chains of molecules regularly aligned in the molten state. It is preferable that the resin composition comprising a liquid crystalline polymer also have liquid crystallinity in the molten state. It is preferable that the resin composition of the present embodiment melt at a temperature of 450° C. or lower.

The resin composition of the present embodiment has high strength, high heat resistance and high dimensional accuracy because of the inclusion of the liquid crystalline polymer.

The liquid crystalline polymer in the resin composition of the present embodiment may be liquid crystal polyester, liquid crystal polyester amide, liquid crystal polyester ether, liquid crystal polyester carbonate or liquid crystal polyester imide.

The liquid crystalline polymer in the resin composition of the present embodiment is preferably liquid crystal polyester, and more preferably an entirely aromatic liquid crystal polyester prepared by using only aromatic compounds as the raw material monomer.

Typical examples of the liquid crystalline polymer in the resin composition of the present embodiment include those prepared by polymerization (polycondensation) of an aromatic hydroxycarboxylic acid, an aromatic dicarboxylic acid, and at least one compound selected from the group consisting of aromatic diol, aromatic hydroxy amine and aromatic diamine, those prepared by polymerizing a plurality of aromatic hydroxycarboxylic acids, those prepared by polymerizing aromatic dicarboxylic acid and at least one compound selected from the group consisting of aromatic diol, aromatic hydroxy amine and aromatic diamine, and those prepared by polymerizing polyester such as polyethylene terephthalate and aromatic hydroxycarboxylic acid. Here, for aromatic hydroxycarboxylic acid, aromatic dicarboxylic acid, aromatic diol, aromatic hydroxy amine and aromatic diamine, a polymerizable derivative thereof may also be each independently used instead of part or all of them.

Examples of polymerizable derivatives of compounds having a carboxyl group, such as aromatic hydroxycarboxylic acid and aromatic dicarboxylic acid, include those in which the carboxyl group is converted into an alkoxycarbonyl group or an aryloxycarbonyl group (ester), those in which the carboxyl group is converted into a haloformyl group (acid halide) and those in which the carboxyl group is converted into an acyloxycarbonyl group (acid anhydride). Examples of polymerizable derivatives of compounds having a hydroxyl group, such as aromatic hydroxycarboxylic acid, aromatic diol and aromatic hydroxy amine, include those in which the hydroxyl group is converted into an acyloxyl group by acylation (an acylated product). Examples of polymerizable derivatives of compounds having an amino group, such as aromatic hydroxy amine and aromatic diamine, include those in which the amino group is converted into an acylamino group by acylation (an acylated product).

The liquid crystalline polymer in the resin composition of the present embodiment has, for example, a flow starting temperature of preferably 280° C. or higher, more preferably 280° C. or higher and 420° C. or lower, and further preferably 300° C. or higher and 400° C. or lower.

As flow starting temperature of the liquid crystalline polymer in the resin composition of the present embodiment is higher, heat resistance, strength and rigidity thereof tend to improve. Meanwhile, when a flow starting temperature of the liquid crystalline polymer becomes higher than 420° C., the melting temperature and the melt viscosity of the resin composition comprising the liquid crystalline polymer tend to become high. Thus, the temperature required for molding the resin composition tends to be high.

The flow starting temperature, also called flow temperature, is the temperature at which liquid crystalline polymer has a viscosity of 4,800 Pa·s (48,000 poise) when the liquid crystalline polymer is melted under a load of 9.8 MPa (100 kg/cm²) while the temperature is increased at a rate of 4° C./min, and extruded through a nozzle with an inner diameter of 1 mm and a length of 10 mm, using a capillary rheometer. The flow starting temperature is an indicator of the molecular weight of liquid crystalline polymer (see p. 95, “Liquid Crystal Polymer—Synthesis, Molding and Application” edited by Naoyuki Koide, CMC, Jun. 5, 1987).

As the liquid crystalline polymer in the resin composition of the present embodiment, liquid crystal polyester having a repeating unit represented by the following formula (1) (u1) (hereinafter also referred to as “a repeating unit (u1)”), a repeating unit represented by the following formula (2) (u2) (hereinafter also referred to as “a repeating unit (u2)”) and a repeating unit represented by the following formula (3) (u3) (hereinafter also referred to as “a repeating unit (u3)”) is particularly preferred.

—O-A^{r1}-CO— (1)

—CO—Ar²—CO— (2)

—X—Ar³—Y— (3)

(in the formulas, Ar¹ represents a phenylene group, Ar² and Ar³ each independently represent a phenylene group or a biphenylylene group; X and Y each independently represent an oxygen atom or an imino group (—NH—); the hydrogen atom in the above groups represented by Ar¹, Ar² and Ar³ may be each independently substituted by a halogen atom, an alkyl group having 1 to 10 carbon atoms or an aryl group having 6 to 20 carbon atoms.)

Repeating Unit (u1)

The repeating unit (u1) is derived from monohydroxybenzoic acid.

In the above formula (1), Ar¹ is a phenylene group, and the hydrogen atom in the phenylene group may be substituted by a halogen atom, an alkyl group having 1 to 10 carbon atoms or an aryl group having 6 to 20 carbon atoms.

Examples of the halogen atoms include a fluorine atom, a chlorine atom, a bromine atom and an iodine atom.

Examples of the alkyl groups include a methyl group, an ethyl group, an n-propyl group, an isopropyl group, an n-butyl group, an isobutyl group, an s-butyl group, a t-butyl group, an n-hexyl group, a 2-ethylhexyl group, an n-octyl group and an n-decyl group.

Examples of the aryl groups include a phenyl group, an o-tolyl group, an m-tolyl group, a p-tolyl group, a 1-naphthyl group and a 2-naphthyl group.

As the repeating unit (u1), among them, a repeating unit in which Ar¹ is a p-phenylene group (a repeating unit derived from p-hydroxybenzoic acid) is preferred.

Repeating Unit (u2)

The repeating unit (u2) is derived from a predetermined aromatic dicarboxylic acid.

Ar² represents a phenylene group or a biphenylylene group. The hydrogen atom in the phenylene group and the biphenylylene group may be substituted by a halogen atom, an alkyl group having 1 to 10 carbon atoms or an aryl group having 6 to 20 carbon atoms. Examples of the halogen atoms, the alkyl groups having 1 to 10 carbon atoms and the aryl groups having 6 to 20 carbon atoms are the same as the halogen atoms, the alkyl groups having 1 to 10 carbon atoms and the aryl groups having 6 to 20 carbon atoms by which the hydrogen atom of the above group represented by Aril may be substituted.

As the repeating unit (u2), out of the above repeating units, a repeating unit in which Ar² is a p-phenylene group (a repeating unit derived from terephthalic acid), a repeating unit in which Ar² is an m-phenylene group (a repeating unit derived from isophthalic acid) and a repeating unit in which Ar² is diphenyl ether-4,4′-diyl group (a repeating unit derived from diphenyl ether-4,4′-dicarboxylic acid) are preferred, and a repeating unit in which Ar² is a p-phenylene group (a repeating unit derived from terephthalic acid) and a repeating unit in which Ar² is a m-phenylene group (a repeating unit derived from isophthalic acid) are more preferred.

Repeating Unit (U3)

The repeating unit (u3) is derived from a predetermined aromatic diol, aromatic hydroxylamine or aromatic diamine.

Ar³ represents a phenylene group or a biphenylylene group. The hydrogen atom in the phenylene group and the biphenylylene group may be substituted by a halogen atom, an alkyl group having 1 to 10 carbon atoms or an aryl group having 6 to 20 carbon atoms. Examples of the halogen atoms, the alkyl groups having 1 to 10 carbon atoms and the aryl groups having 6 to 20 carbon atoms are the same as the halogen atoms, the alkyl groups having 1 to 10 carbon atoms and the aryl groups having 6 to 20 carbon atoms by which the hydrogen atom of the above group represented by Ar¹ may be substituted.

X and Y each independently represent an oxygen atom or an imino group (—NH—). It is preferable that both be an oxygen atom.

As the repeating unit (u3), out of the above repeating units, a repeating unit in which Ar³ is a p-phenylene group (a repeating unit derived from hydroquinone, p-aminophenol or p-phenylenediamine) and a repeating unit in which Ar³ is a 4,4′-biphenylylene group (a repeating unit derived from 4,4′-dihydroxybiphenyl, 4-amino-4′-hydroxybiphenyl or 4,4′-diaminobiphenyl) are preferred, and a repeating unit in which Ara is a 4,4′-biphenylylene group and X and Y are an oxygen atom (a repeating unit derived from 4,4′-dihydroxybiphenyl) is more preferred.

The number of repeating units (u1) is preferably 30% or more, more preferably 40% or more and further preferably 50% or more based on the total number of the repeating units (100%).

Meanwhile, the number of repeating units (u1) is preferably 80% or less, more preferably 70% or less and further preferably 65% or less based on the total number of the repeating units.

For example, the number of repeating units (u1) in liquid crystal polyester is preferably 30% or more and 80% or less, more preferably 40% or more and 70% or less, and further preferably 50% or more and 65% or less.

The number of repeating units (u2) is preferably 7% or more, more preferably 10% or more and further preferably 15% or more based on the total number of the repeating units.

Meanwhile, the number of repeating units (u2) is preferably 35% or less, more preferably 30% or less and further preferably 25% or less based on the total number of the repeating units.

For example, the number of repeating units (u2) in liquid crystal polyester is preferably 7% or more and 35% or less, more preferably 10% or more and 30% or less, and further preferably 15% or more and 25% or less.

The number of repeating units (u3) is preferably 7% or more, more preferably 10% or more and further preferably 15% or more based on the total number of the repeating units.

Meanwhile, the number of repeating units (u3) is preferably 35% or less, more preferably 30% or less and further preferably 25% or less based on the total number of the repeating units.

For example, the number of repeating units (u3) in liquid crystal polyester is preferably 7% or more and 35% or less, more preferably 10% or more and 30% or less, and further preferably 15% or more and 25% or less.

In the liquid crystal polyester having a repeating unit (u1), a repeating unit (u2) and a repeating unit (u3), the sum of the number of repeating units (1), the number of repeating units (2) and the number of repeating units (3) does not exceed 100%.

In the present description, the number of the respective repeating units may be measured, for example, by the analytical method described in Japanese Patent Laid-Open No. 2000-19168.

Specifically, liquid crystal polyester resin is reacted with lower alcohol (alcohol having 1 to 3 carbon atoms) in the super critical state to depolymerize the liquid crystal polyester resin into monomers from which the repeating unit is derived, and the amount of the monomers which are the product of depolymerization and from which the respective repeating unit is derived may be determined by liquid chromatography to calculate the number of the respective repeating units.

For example, when the liquid crystal polyester resin consists of repeating units (u1) to (u3), the number of repeating units (u1) may be determined by calculating the molar concentration of the monomer from which each of the repeating units (u1) to (u3) is derived by liquid chromatography and calculating the ratio of the molar concentration of the monomer from which the repeating unit (u1) is derived when the total molar concentration of the monomers from which each of the repeating units (u1) to (u3) is derived is 100%.

The liquid crystal polyester with such a predetermined composition of repeating units has excellent heat resistance and thermal stability. As the number of repeating units (u1) is more, melt flowability, heat resistance, thermal stability, strength and rigidity are likely to improve, but too many repeating units tend to increase melting temperature and melt viscosity, and the temperature required for molding tends to be high.

It is preferable that the number of repeating units (u2) and the number of repeating units (u3) in the liquid crystal polyester be substantially the same.

More specifically, the ratio of the number of repeating units (u2) to the number of repeating units (u3), which is represented by [number of repeating units (u2)]/[number of repeating units (u3)], is, for example, 0.9/1 to 1/0.9, preferably 0.95/1 to 1/0.95 and more preferably 0.98/1 to 1/0.98.

The liquid crystal polyester may each independently have two or more of the repeating units (u1) to (u3). Furthermore, the liquid crystal polyester may have a repeating unit other than the repeating units (u1) to (u3), and the ratio of the number of the repeating unit, for example, is 10% or less and preferably 5% or less based on the total number of the repeating units.

For the liquid crystalline polymer in the resin composition of the present embodiment, specific examples of highly heat resistant and highly thermally stable liquid crystalline polymers include a liquid crystal polyester comprising, based on the total number of the repeating units:
(i) preferably 40% or more and 80% or less, more preferably 45% or more and 75% or less, and further preferably 50% or more and 70% or less of a repeating unit (u1) in which Ar¹ is a p-phenylene group (i.e., a repeating unit derived from p-hydroxybenzoic acid);
(ii) preferably 1% or more and 30% or less, more preferably 10% or more and 25% or less, and further preferably 15% or more and 20% or less of a repeating unit (u2) in which Ar² is a p-phenylene group (i.e., a repeating unit derived from terephthalic acid);
(iii) preferably 1% or more and 15% or less, more preferably 1% or more and 10% or less, and further preferably 1% or more and 5% or less of a repeating unit (u2) in which Ar² is an m-phenylene group (i.e., a repeating unit derived from isophthalic acid); and
(iv) preferably 5% or more and 40% or less, more preferably 10% or more and 30% or less, and further preferably 15% or more and 25% or less of a repeating unit (u3) in which Ara is a 4,4′-biphenylylene group and X and Y are an oxygen atom (i.e., a repeating unit derived from 4,4′-dihydroxybiphenyl).

In the liquid crystal polyester having a repeating unit (u1), a repeating unit (u2) and a repeating unit (u3), the sum of the number of repeating units (1), the number of repeating units (2) and the number of repeating units (3) does not exceed 100%.

The number of the respective repeating units described above is close to the ratio (mole %) of the respective repeating units calculated from the amount of charge of the raw material monomers.

Thus, preferred ratios (mole %) of the respective repeating units calculated from the amount of charge of the raw material monomers are each similar to the preferred number of the respective repeating units (%) described above.

It is preferable that the liquid crystalline polymer of the present embodiment be each produced by melt polymerization of raw material monomers corresponding to the repeating unit constituting the polymer and by solid state polymerization of the resulting polymer. This makes it possible to produce a high molecular weight liquid crystalline polymer having high heat resistance, thermal stability, strength and rigidity with good operationability.

Melt polymerization may be performed in the presence of a catalyst. Examples of catalysts include a metallic compound such as magnesium acetate, tin (II) acetate, tetrabutyl titanate, lead acetate, sodium acetate, potassium acetate and antimony trioxide and a nitrogen-containing heterocyclic compound such as 4-(dimethylamino)pyridine and 1-methylimidazole. A nitrogen-containing heterocyclic compound is preferably used.

It is preferable that the liquid crystalline polymer of the present embodiment be melt-kneaded using an extruder and then formed into pellets.

An extruder having a cylinder, one or more screws provided inside the cylinder and one or more supply ports provided in the cylinder is preferably used. An extruder having one or more vents provided in the cylinder is more preferred as the extruder. Furthermore, it is preferable to use an extruder having a kneading unit at the downstream of the supply port (at the downstream of the respective supply ports when the extruder has a plurality of supply ports). The kneading unit is defined as a part which is provided on a part of the screw and performs melt-kneading efficiently. Examples of the kneading unit include a kneading disc (forward kneading disc, neutral kneading disc and reverse kneading disc) and a mixing screw.

It is preferable that in the extruder, a decompression member be connected to the position with one or more vents. Deaeration of the cylinder of the extruder using the decompression member at the time of melt-kneading of the liquid crystalline polymer enables remaining low molecular weight components to be removed from the liquid crystalline polymer.

One kind of liquid crystalline polymer may be used alone or two or more kinds of liquid crystalline polymers may be used in combination as the liquid crystalline polymer in the resin composition of the present embodiment.

The content of the liquid crystalline polymer in the resin composition of the present embodiment is preferably 30% by mass or more, more preferably 40% by mass or more and further preferably 55% by mass or more based on the total amount of the resin composition.

Meanwhile, the content of the liquid crystalline polymer is preferably 95% by mass or less, more preferably 70% by mass or less, and further preferably 65% by mass or less based on the total amount of the resin composition.

The content of the liquid crystalline polymer, for example, is preferably 30% by mass or more and 95% by mass or less, more preferably 40% by mass or more and 70% by mass or less, and further preferably 55% by mass or more and 65% by mass or less based on the total amount of the resin composition.

<Fluororesin>

The fluororesin in the resin composition of the present embodiment has a peak area percentage of the CF₃ groups content relative to the CF₂ groups content in the fluororesin of 0.05% or more as determined by the following [Method for measuring CF₃ groups content].

[Method for Measuring CF₃ Groups Content]:

The CF₃ groups content relative to the CF₂ groups content in the fluororesin is calculated as an area percentage from a peak area ICF₃ corresponding to the CF₃ groups and a peak area ICF₂ corresponding to the CF₂ groups measured by ¹⁹F solid-state NMR, and is determined by the following formula (f1):

CF₃ groups content (%)={(ICF₃)/3/(ICF₂)/2}×100 (f1)

The peak area percentage of the CF₃ groups content is determined based on the content described in Macromolecules 2001, 34, 66-75.

Examples of NMR apparatus for the measurement of solid specimen include a 400 MHz NMR apparatus (made by JEOL Ltd., Bruker, Agilent Technologies, or Varian and the like).

¹⁹F solid-state NMR measurement for calculating the CF₃ groups content is performed, for example, by a single pulse method. Conditions of the measurement are as follows.
Measurement apparatus: PS400WB (Varian)
Strength of static magnetic field: 9.4 Tesla (Resonance frequency: 400 MHz (1H))
Magic angle spinning: 35 kHz (35,000 revolutions per second)
Repetition time: 15 s
Cumulative number: 128 times
Temperature: 26° C.
Chemical shift reference material: hexafluorobenzene

In the fluororesin in the resin composition of the present embodiment, the peak area percentage of the CF₃ groups content relative to the CF₂ groups content in the fluororesin as determined by the above [Method for measuring CF₃ groups content]: is 0.05% or more, preferably 0.05% or more and 1.0% or less, more preferably 0.05% or more and 0.20% or less, further preferably 0.05% or more and 0.15% or less, and particularly preferably 0.05% or more and 0.10% or less.

Because the fluororesin in the resin composition of the present embodiment has a peak area percentage of the CF₃ groups content of 0.05% or more, the resin composition of the present embodiment comprising the fluororesin has good effects of suppressing occurrence of die swell.

Meanwhile, when the peak area percentage of the CF₃ groups content is the above preferred upper limit or less, thermal stability of the resin composition further improves.

The fluororesin in the resin composition of the present embodiment has an decomposition starting temperature of resin of preferably 450° C. or higher, more preferably 470° C. or higher, and further preferably 473° C. or higher.

The decomposition starting temperature of resin is a temperature at which the ratio of weight reduction becomes 0.1% when the fluororesin is heated from 25° C. (room temperature) to 800° C. under conditions of temperature increasing ratio of 10° C./minute using a thermogravimetry unit (product name: TGA-50 made by Shimadzu Corporation).

The upper limit of the decomposition starting temperature of resin of the fluororesin in the resin composition of the present embodiment is not particularly limited, and is for example, 600° C. or lower.

The decomposition starting temperature of resin of the fluororesin in the resin composition of the present embodiment is, for example, preferably 450° C. or higher and 600° C. or lower, more preferably 470° C. or higher and 600° C. or lower, and further preferably 473° C. or higher and 600° C. or lower.

The fluororesin in the resin composition of the present embodiment has a number average molecular weight (Mn) of preferably 100 to 5,000,000, more preferably 200 to 1,000,000, further preferably 300 to 50,000, and particularly preferably 10,000 to 30,000.

In the present description, the number average molecular weight (Mn) is determined by the method described in J. Appl. Polym. Sci. 1973, 17, 3253. Specifically, the number average molecular weight (Mn) means a value calculated by the following equation (m-1) based on the amount of heat of crystallization (ΔHc: cal/g) determined by using a differential scanning calorimeter (product name: DSC-50 made by Shimadzu Corporation). Here the amount of heat of crystallization (ΔHc) is the amount of heat calculated from the area of the crystallization peak in the DSC curve.

Number average molecular weight (Mn)=2.1×10¹⁰ΔHc^{-5.16} (m-1)

When the fluororesin in the resin composition of the present embodiment has a number average molecular weight (Mn) in the above preferred range, thermal stability and effects of suppressing occurrence of die swell are more improved.

The peak area percentage of the CF₃ groups content, the decomposition starting temperature of resin and the number average molecular weight (Mn) of the above fluororesin may be controlled by modifying the method for producing the fluororesin.

For example, for the peak area percentage of the CF₃ groups content of fluororesin, a fluororesin having a peak area percentage of the CF₃ groups content of 0.05% or more may be obtained by increasing branched chains of the fluororesin, controlling the polymerization degree of the fluororesin and controlling the ratio of mixing of raw material monomers.

Specific examples of fluororesins in the resin composition of the present embodiment include polytetrafluoroethylene (PTFE), tetrafluoroethylene-hexafluoropropylene copolymer (FEP), polychlorotrifluoroethylene (PCTFE), ethylene-tetrafluoroethylene copolymer, ethylene-chlorotrifluoroethylene copolymer, polyvinylidene fluoride (PVDF) and tetrafluoroethylene-perfluoroalkyl vinyl ether copolymer (perfluoroalkoxyalkane, PFA).

Of the above, PTFE is preferred as the fluororesin in the resin composition of the present embodiment from the viewpoint of improvement of thermal stability and effects of suppressing occurrence of die swell.

In other words, as the fluororesin in the resin composition of the present embodiment, PTFE having a peak area percentage of the CF₃ groups content relative to the CF₂ groups content of 0.05% or more as determined by the above [Method for measuring CF₃ groups content] is preferred, PTFE having a peak area percentage of the CF₃ groups content of 0.05% or more and 1.0% or less is more preferred, PTFE having a peak area percentage of the CF₃ groups content of 0.05% or more and 0.20% or less is further preferred, and PTFE having a peak area percentage of the CF₃ groups content of 0.05% or more and 0.10% or less is still more preferred.

Furthermore, PTFE having an decomposition starting temperature of resin of 450° C. or higher and 600° C. or lower is preferred, PTFE having an decomposition starting temperature of resin of 470° C. or higher and 600° C. or lower is more preferred, and PTFE having an decomposition starting temperature of resin of 473° C. or higher and 600° C. or lower is further preferred as the fluororesin in the resin composition of the present embodiment.

Furthermore, PTFE having a number average molecular weight (Mn) of 100 to 5,000,000 is preferred, PTFE having a number average molecular weight (Mn) of 200 to 1,000,000 is more preferred, PTFE having a number average molecular weight (Mn) of 300 to 50,000 is further preferred, and PTFE having a number average molecular weight (Mn) of 10,000 to 30,000 is still more preferred as the fluororesin in the resin composition of the present embodiment.

One fluororesin may be used alone or two or more of them may be used in combination as the fluororesin in the resin composition of the present embodiment.

The content of the fluororesin in the resin composition of the present embodiment is preferably 0.05% by mass or more, more preferably 0.10% by mass or more, and further preferably 0.50% by mass or more based on the total amount of the resin composition.

Meanwhile, the content of the fluororesin in the resin composition of the present embodiment is preferably 5.0% by mass or less, more preferably 1.5% by mass or less, and further preferably 1.0% by mass or less based on the total amount of the resin composition.

For example, the content of the fluororesin is preferably 0.05% by mass or more and 5.0% by mass or less, more preferably 0.10% by mass or more and 1.5% by mass or less, and further preferably 0.50% by mass or more and 1.0% by mass or less based on the total amount of the resin composition.

When the content of the fluororesin in the resin composition of the present embodiment based on the total amount of the resin composition is in the above preferred range, effects of suppressing occurrence of die swell are more improved.

The content of the fluororesin in the resin composition of the present embodiment is preferably 0.1 part by mass or more, more preferably 0.5 part by mass or more, and further preferably 1.0 part by mass or more based on 100 parts by mass of the liquid crystalline polymer described above.

Meanwhile, the content of the fluororesin is preferably 5.0 parts by mass or less, more preferably 3.0 parts by mass or less, and further preferably 2.0 parts by mass or less based on 100 parts by mass of the liquid crystalline polymer.

For example, the content of the fluororesin is preferably 0.1 part by mass or more and 5.0 parts by mass or less, more preferably 0.5 part by mass or more and 3.0 parts by mass or less, and further preferably 1.0 part by mass or more and 2.0 parts by mass or less.

When the content of the fluororesin in the resin composition of the present embodiment based on 100 parts by mass of liquid crystalline polymer is in the above preferred range, thermal stability and effects of suppressing occurrence of die swell are more improved.

When PTFE is used as the fluororesin in the resin composition of the present embodiment, the fluororesin in the resin composition of the present embodiment may be produced, for example, by the following method for producing (i) or (ii).

Method for Producing (i)

Method for producing (i) is a method for producing polytetrafluoroethylene (PTFE) using emulsion polymerization and suspension polymerization in combination. Specifically, tetrafluoroethylene is polymerized in the presence of a polymerization initiator (water-soluble peroxide) and an aqueous medium (e.g., deionized high purity pure water) to prepare emulsified particles. Then the emulsified particles are coagulated to give coagulated powder. Subsequently, by polymerizing tetrafluoroethylene in the presence of the coagulated powder, a polymerization initiator and an aqueous medium, polytetrafluoroethylene (PTFE) with the peak area percentage of the CF₃ groups content described above in the above range may be produced.

Method for Producing (ii)

Method for producing (ii) is a method in which tetrafluoroethylene and at least one optional comonomer are polymerized in an aqueous polymerization medium.

Specifically, polytetrafluoroethylene (PTFE) with the peak area percentage of the CF₃ groups content described above in the above range may be produced by polymerizing tetrafluoroethylene and at least one copolymerizable ethylenically unsaturated fluorinated comonomer (e.g., perfluoro(propylvinyl ether) (PPVE)) in the presence of a specific dispersant (e.g., a mixture of perfluoroalkyl(C₄ to C₁₆) ammonium ethanesulfonate) with adjusting the ratio of mixing each monomer.

It is preferable that the content of the comonomer in PTFE be, for example, 0.005% by mole to 20% by mole.

A fluororesin produced by the method for producing (ii) of the above is preferred as the fluororesin in the resin composition of the present embodiment.

<Optional Components>

The resin composition of the present embodiment comprises the liquid crystalline polymer and the fluororesin described above and may further comprise a component other than those (optional components) to the extent that the effects of the present invention are achieved.

Examples of optional components include a glass fiber, an inorganic filler other than glass fiber, a pigment and an additive.

<<Glass Fiber>>

The type of glass fiber in the resin composition of the present embodiment is not particularly limited and a known glass fiber may be used. Examples thereof include E glass (i.e., non-alkaline glass), C glass (i.e., glass for acid resistant applications), AR glass (e.g., glass for alkali resistant applications), S glass and T glass.

Of them, E glass is preferred as a glass fiber.

A glass fiber may be an untreated glass fiber or a treated glass fiber.

A glass fiber may be treated with a sizing agent, a silane coupling agent, a boron compound and the like. Examples of sizing agents include an aromatic urethane sizing agent, an aliphatic urethane sizing agent and an acrylic sizing agent.

The fiber diameter of the glass fiber in the resin composition of the present embodiment is not particularly limited, and the glass fiber has a fiber diameter of, for example, preferably 1 to 40 μm, more preferably 3 to 35 μm and further preferably 5 to 15 μm.

The fiber length of the glass fiber in the resin composition of the present embodiment is not particularly limited, and the glass fiber has a fiber length of, for example, preferably 10 to 150 μm, more preferably 30 to 125 μm, and further preferably 50 to 100 μm.

The fiber diameter and the fiber length of the glass fiber in the resin composition of the present embodiment may be measured, for example, by a scanning electron microscope or an optical microscope.

One kind of glass fibers may be used alone or two or more kinds of thereof may be used in combination as the glass fiber in the resin composition of the present embodiment.

The content of the glass fiber in the resin composition of the present embodiment is preferably 10% by mass or more, more preferably 20% by mass or more, and further preferably 35% by mass or more based on the total amount of the resin composition.

Meanwhile, the content of the glass fiber is preferably 70% by mass or less, more preferably 60% by mass or less, and further preferably 45% by mass or less based on the total amount of the resin composition.

The content of the glass fiber, for example, is preferably 10% by mass or more and 70% by mass or less, more preferably 20% by mass or more and 60% by mass or less, and further preferably 35% by mass or more and 45% by mass or less based on the total amount of the resin composition.

When the content of the glass fiber in the resin composition of the present embodiment is in the above preferred range, not only effects of suppressing occurrence of die swell but also mechanical strength of the molded body can be more improved.

When the resin composition of the present embodiment comprises a glass fiber, the content of the fluororesin described above is preferably 0.05 part by mass or more, more preferably 0.10 part by mass or more, and further preferably 0.50 part by mass or more based on 100 parts by mass of the liquid crystalline polymer and the glass fiber described above.

Meanwhile, the content of the fluororesin is preferably 5.0 parts by mass or less, more preferably 1.5 parts by mass or less, and further preferably 1.0 part by mass or less based on 100 parts by mass of the liquid crystalline polymer and the glass fiber described above.

The content of the fluororesin, for example, is preferably 0.05 part by mass or more and 5.0 parts by mass or less, more preferably 0.10 part by mass or more and 1.5 parts by mass or less, and further preferably 0.50 part by mass or more and 1.0 part by mass or less based on 100 parts by mass of the liquid crystalline polymer and the glass fiber described above.

When the content of the fluororesin in the resin composition of the present embodiment based on the liquid crystalline polymer and the glass fiber is in the above preferred range, the balance between thermal stability, effects of suppressing occurrence of die swell and mechanical strength are improved.

<<Inorganic Filler Other than Glass Fiber>>

The inorganic filler other than a glass fiber in the resin composition of the present embodiment may be a fibrous filler, a plate filler, or a particulate filler other than the fibrous filler or plate filler.

It is preferable that the inorganic filler in the resin composition of the present embodiment be a plate filler among the above fillers.

Specific examples of plate filler include talc and mica.

Talc

Those prepared by pulverizing hydrous magnesium silicate are preferred as talc in the resin composition of the present embodiment.

The crystalline structure of hydrous magnesium silicate molecules is a three-layer pyrophyllite structure, and those structures are stacked in talc.

Plate talc, in which crystals of hydrous magnesium silicate molecules are pulverized down to about a single layer, is more preferred as talc.

Talc may be untreated talc or treated talc.

Examples of treated talc include talc surface-treated with a known surfactant. Examples of surfactants include a silane coupling agent, a titanium coupling agent, higher fatty acid, higher fatty acid ester, higher fatty acid amide, and higher fatty acid salt.

Talc has a median diameter (D50) of preferably 5 to 30 μm, and more preferably 10 to 25 μm.

The median diameter (D50) of talc can be measured, for example, by a known laser diffraction particle size distribution analyzer.

One kind of talc may be used alone or two or more kinds of talc may be used in combination as the talc in the resin composition of the present embodiment.

The content of talc in the resin composition of the present embodiment is preferably 5% by mass or more, more preferably 15% by mass or more and further preferably 25% by mass or more based on the total amount of the resin composition.

Meanwhile, the content of talc is preferably 80% by mass or less, more preferably 70% by mass or less, and further preferably 60% by mass or less based on the total amount of the resin composition.

The content of talc, for example, is preferably 5% by mass or more and 80% by mass or less, more preferably 15% by mass or more and 70% by mass or less, and further preferably 25% by mass or more and 60% by mass or less based on the total amount of the resin composition.

When the content of talc in the resin composition of the present embodiment is in the above range, mechanical strength of molded bodies prepared using the resin composition can be more improved.

Mica

Mica is pulverized silicate mineral including aluminum, potassium, magnesium, sodium, iron and the like. Mica has a structure in which two or three octahedral structures made of metal oxide/hydroxide are sandwiched between four tetrahedral structures made of oxide of three silicon atoms (Si) and an aluminum atom (Al).

Mica in the present embodiment may be any of a natural mica such as muscovite, phlogopite, fluorine phlogopite and tetrasilicic mica and synthesized mica artificially produced.

Mica may be untreated mica or treated mica.

Examples of treated mica include mica surface-treated with a known surfactant. Examples of surfactants include a silane coupling agent, a titanium coupling agent, higher fatty acid, higher fatty acid ester, higher fatty acid amide, and higher fatty acid salt.

Mica has a median diameter (D50) of preferably 5 to 30 μm, and more preferably 10 to 25 μm.

The median diameter (D50) of mica may be measured, for example, by a known laser diffraction particle size distribution analyzer.

One kind of mica may be used alone or two or more kinds of mica may be used in combination as the mica in the resin composition of the present embodiment.

The content of mica in the resin composition of the present embodiment is preferably 5% by mass or more, more preferably 15% by mass or more, and further preferably 25% by mass or more based on the total amount of the resin composition.

Meanwhile, the content of mica is preferably 80% by mass or less, more preferably 70% by mass or less and further preferably 60% by mass or less based on the total amount of the resin composition.

The content of mica, for example, is preferably 5% by mass or more and 80% by mass or less, more preferably 15% by mass or more and 70% by mass or less, and further preferably 25% by mass or more and 60% by mass or less based on the total amount of the resin composition.

When the content of mica in the resin composition of the present embodiment is in the above range, mechanical strength of molded bodies prepared using the resin composition can be more improved.

<<Pigment>>

Examples of pigments include alumina, iron oxide, cobalt oxide, chromium oxide, manganese oxide, titanium oxide, carbon black and titanium yellow. Of them, carbon black and titanium oxide are preferred.

One kind of pigments may be used alone or two or more kinds of pigments may be used in combination as the pigment in the resin composition of the present embodiment.

The content of the pigment in the resin composition of the present embodiment is preferably 0.05% by mass or more, more preferably 0.1% by mass or more, and further preferably 0.5% by mass or more based on the total amount of the resin composition.

Meanwhile, the content of the pigment is preferably 10% by mass or less, more preferably 7% by mass or less and further preferably 5% by mass or less based on the total amount of the resin composition.

The content of the pigment, for example, is preferably 0.05% by mass or more and 10% by mass or less, more preferably 0.1% by mass or more and 7% by mass or less, and further preferably 0.5% by mass or more and 5% by mass or less based on the total amount of the resin composition.

Carbon Black

The content of carbon black in the resin composition of the present embodiment is preferably 0.05% by mass or more, more preferably 0.1% by mass or more, and further preferably 0.5% by mass or more based on the total amount of the resin composition.

Meanwhile, the content of carbon black is preferably 5% by mass or less, more preferably 3% by mass or less, and further preferably 1.5% by mass or less based on the total amount of the resin composition.

The content of carbon black, for example, is preferably 0.05% by mass or more and 5% by mass or less, more preferably 0.1% by mass or more and 3% by mass or less, and further preferably 0.5% by mass or more and 1.5% by mass or less based on the total amount of the resin composition.

The primary particle of carbon black may have an average particle size of, for example, 20 to 50 nm, or 20 to 40 nm.

The primary particle size of carbon black may be measured by the method described in p. 114, Carbon Black Almanac No. 48 (1998) published by the Carbon Black Association.

Specifically, carbon black is observed at a magnification of 20,000 times using a transmission electron microscope, and the diameter of the primary particle of 1,000 random carbon black particles is measured and the number average is determined to calculate the primary particle size of carbon black.

Carbon black may have a specific surface area of, for example, 30 to 200 m²/g or 50 to 160 m2/g.

The specific surface area of carbon black refers to the nitrogen adsorption specific surface area. For the measurement of the nitrogen adsorption specific surface area, gas and the like attached to the surface of a sample is previously removed, and nitrogen is adsorbed to the sample at liquid nitrogen temperature, and the specific surface area may be calculated from the amount of adsorption.

Specifically, nitrogen gas is adsorbed to a sample at liquid nitrogen temperature according to JIS K6217-2:2001 using a BET specific surface area meter (e.g., AccuSorb 2100E made by Micromeritics) to measure the amount of adsorption, and the specific surface area may be calculated by the BET method.

The amount of oil absorption of carbon black may be 30 mL/100 g or more and 120 mL/100 g or less, or 40 mL/100 g or more and 80 mL/100 g or less.

The amount of oil absorption of carbon black may be measured by dibutyl phthalate absorption meter by the method according to JIS K6217-4: 2001.

Titanium Oxide

Titanium oxide in the resin composition of the present embodiment is not particularly limited, and known titanium oxide may be used.

The crystalline structure of titanium oxide is not particularly limited, and may be a rutile type or anatase type, or a mixture of the two.

Titanium oxide which has been surface treated may also be used.

Surface treatment of titanium oxide using inorganic metal oxide, for example, may improve properties such as dispersibility. Examples of inorganic metal oxides include aluminum oxide.

Titanium oxide has an average particle size of preferably 0.1 to 1 μm, and more preferably 0.15 to 0.25 μm.

The average particle size of titanium oxide may be measured, for example, by a known laser diffraction particle size distribution analyzer.

One kind of titanium oxide may be used alone or two or more kinds of titanium oxide may be used in combination as the titanium oxide in the resin composition of the present embodiment.

The content of titanium oxide in the resin composition of the present embodiment is preferably 0.5% by mass or more, more preferably 1% by mass or more, and further preferably 2% by mass or more based on the total amount of the resin composition.

Meanwhile, the content of titanium oxide is preferably 10% by mass or less, more preferably 7% by mass or less and further preferably 5% by mass or less based on the total amount of the resin composition.

The content of titanium oxide, for example, is preferably 0.5% by mass or more and 10% by mass or less, more preferably 1% by mass or more and 7% by mass or less, and further preferably 2% by mass or more and 5% by mass or less based on the total amount of the resin composition.

When the content of titanium oxide in the resin composition of the present embodiment is in the above range, mechanical strength of molded bodies prepared using the resin composition can be more improved.

<<Additives>>

Examples of additives include a flame retarder, a conductivity imparting agent, a crystal nucleating agent, an ultraviolet absorber, an antioxidant, a vibration damping agent, an antibacterial agent, an insect repellent, a deodorant, an anti-coloring agent, a thermal stabilizer, a release agent, an antistatic agent, a plasticizer, a lubricant, a dye, a foaming agent, an anti-foaming agent, a viscosity adjuster and a surfactant.

The resin composition of the present embodiment described above comprises a liquid crystalline polymer and a fluororesin, and the fluororesin has a peak area percentage of the CF₃ groups content relative to the CF₂ groups content in the fluororesin of 0.05% or more, as determined by the above [Method for CF₃ groups content].

Using a liquid crystalline polymer and a fluororesin having a peak area percentage of the CF₃ groups content of 0.05% or more in combination, the resin composition of the present embodiment can further improve effects of suppressing occurrence of die swell.

Furthermore, using a liquid crystalline polymer and a fluororesin having a peak area percentage of the CF₃ groups content of 0.05% or more in combination, the resin composition of the present embodiment can further improve thermal stability.

The present invention includes the following aspects.

<1> A resin composition comprising a liquid crystalline polymer and a fluororesin, wherein the fluororesin has a peak area percentage of a CF₃ groups content relative to a CF₂ groups content in the fluororesin of 0.05% or more, preferably 0.05% or more and 1.0% or less, more preferably 0.05% or more and 0.20% or less, and further preferably 0.05% or more and 0.10% or less as determined by the following [Method for measuring CF₃ groups content].

[Method for Measuring CF₃ Groups Content]:

The CF₃ groups content relative to the CF₂ groups content in the fluororesin is calculated as an area percentage from a peak area ICF₃ corresponding to the CF₃ group and a peak area ICF₂ corresponding to the CF₂ group measured by 19F solid-state NMR, and is determined by the following formula (f1):

CF₃ groups content (%)={(ICF₃)/3/(ICF₂)/2}×100 (f1)

<2> The resin composition according to <1>, wherein the liquid crystalline polymer is a liquid crystal polyester comprising a repeating unit (u1) represented by the following formula (1), a repeating unit (u2) represented by the following formula (2) and a repeating unit (u3) represented by the following formula (3):

—O—Ar¹—CO— (1)

—CO—Ar²—CO— (2)

—X—Ar³—Y— (3)

(in the formula, Ar¹ represents a phenylene group, Ar² and Ar³ each independently represent a phenylene group or a biphenylylene group; X and Y each independently represent an oxygen atom or an imino group (—NH—); the hydrogen atom in the above groups represented by Ar¹, Ar² and Ar³ may be each independently substituted by a halogen atom, an alkyl group having 1 to 10 carbon atoms or an aryl group having 6 to 20 carbon atoms.)

<3> The resin composition according to <1> or <2>, wherein the content of the liquid crystalline polymer is preferably 30% by mass or more and 95% by mass or less, more preferably 40% by mass or more and 70% by mass or less, and further preferably 55% by mass or more and 65% by mass or less based on the total amount of the resin composition, and
the content of the fluororesin is preferably 0.05% by mass or more and 5.0% by mass or less, more preferably 0.10% by mass or more and 1.5% by mass or less, further preferably 0.50% by mass or more and 1.0% by mass or less based on the total amount of the resin composition.

<4> The resin composition according to any one of <1> to <3>, wherein the fluororesin is polytetrafluoroethylene (PTFE).

<5> The resin composition according to any one of <1> to <4>, further comprising a glass fiber.

<6> The resin composition according to <5>, wherein the content of the glass fiber is preferably 10% by mass or more and 70% by mass or less, more preferably 20% by mass or more and 60% by mass or less, and further preferably 35% by mass or more and 45% by mass or less based on the total amount of the resin composition.

<7> The resin composition according to any one of <1> to <6>, further comprising a plate filler.

<8> The resin composition according to any one of <1> to <7>, wherein the fluororesin has an decomposition starting temperature of resin of 473° C. or higher.

<9> A resin composition whose 64 mm-wide, 64 mm-long and 3 mm-thick specimen prepared by injection molding, by using the resin composition according to any one of <1> to <8> has a ratio of change between b* immediately after preparing the specimen and b* after heating the specimen at 300° C. for 2 hours of preferably 12% or less, more preferably 9% or less, further preferably 5% or less and particularly preferably less than 3.3% when b* immediately after preparing the specimen and b* after heating the specimen at 300° C. for 2 hours are measured using a colorimeter.

(Method for Producing Resin Composition)

The method for producing the resin composition of the present embodiment comprises: a step for preparing a fluororesin having a peak area percentage of the CF₃ groups content relative to the CF₂ groups content in the fluororesin of 0.05% or more as determined by the following [Method for measuring CF₃ groups content]; and a step for mixing the fluororesin and a liquid crystalline polymer:

[Method for Measuring CF₃ Groups Content]:

The CF₃ groups content relative to the CF₂ groups content in the fluororesin is calculated as an area percentage from a peak area ICF₃ corresponding to the CF₃ group and a peak area ICF₂ corresponding to the CF₂ group measured by ¹⁹F solid-state NMR, and is determined by the following formula (f1):

CF₃ groups content (%)={(ICF₃)/3/(ICF₂)/2}×100 (f1)

Specific examples of steps for preparing a fluororesin having a peak area percentage of the CF₃ groups content of 0.05% or more include the methods (i) to (iv) described above. Of them, the methods (ii) to (iv) are preferred.

(Molded Body)

The molded body of the present embodiment is prepared by using the above resin composition.

The molded body of the present embodiment may be prepared by using the resin composition by a known molding method. Melt molding methods are preferred as the method for molding the resin composition of the present embodiment. Examples thereof include injection molding, extrusion molding such as a T-die method and an inflation method, compression molding, blow molding, vacuum molding and press molding. Of them, injection molding is preferred.

For example, when the above resin composition is molded as a molding material by injection molding, the resin composition is melted and the molten resin composition is injected into a mold using a known injection molding machine.

When the resin composition is introduced into the injection molding machine, the respective components may be individually introduced into the injection molding machine, or part or all of the components may be previously mixed and the mixture may be introduced into the injection molding machine.

Examples of known injection molding machines include TR450EH3 made by Sodick Co., Ltd. and a hydraulic horizontal injection molding machine, PS40E5ASE Model made by Nissei Plastic Industrial Co., Ltd.

Temperature conditions of injection molding are determined as needed depending on the type of liquid crystalline polymer. It is preferable to set the cylinder temperature of the injection molding machine to a temperature 10 to 80° C. higher than the flow starting temperature of the liquid crystalline polymer used.

It is preferable that the temperature of the mold be set at room temperature (25° C.) to 180° C. from the viewpoint of cooling rates of the resin composition and productivity.

For other injection conditions, the number of revolution of screws, back pressure, injection rates, dwelling, dwelling time and the like may be adjusted as needed.

The molded body of the present embodiment may be used in various applications to which liquid crystalline polymer may usually be applied.

Examples of molded bodies of the present embodiment include electric and electronic components such as a connector, a socket, a relay part, a coil bobbin, an optical pickup, an oscillator, a printed wiring board, a circuit board, a semiconductor package and a computer-related part; components related to process for producing semiconductors such as an IC tray and a wafer carrier; components of home electric appliances such as a VTR, a television, an iron, an air conditioner, a stereo, a vacuum cleaner, a refrigerator, a rice cooker and a lighting equipment; lighting components such as a lamp reflector and a lamp holder; components of acoustic products such as a compact disc, a laser disc (registered trademark) and a speaker; components of communication devices such as a ferrule for optical cable, a phone part, a facsimile part and a modem; copying machine or printer components such as a separation claw and a heater holder; mechanical components such as an impeller, a fan gear, a gear, a bearing, a motor part and a case; automobile components such as an automobile mechanical component, an engine component, an engine room component, an electrical component and an interior component; cooking utensils such as a microwave cooking pan and a heat resistant plate; insulation and sound proof materials such as a floor material and a wall material, supporting materials such as a beam and a pillar, building materials such as a roof material or a civil engineering material; components of aircrafts, spacecrafts and space appliances; components of radiation facility such as a nuclear reactor, components for off-shore facility, cleaning tools, components of an optical device, valves, pipe, nozzles, filter, membrane, components for medical devices and medical materials, components of sensors, sanitary supplies, sporting goods and leisure goods.

Of them, it is preferable that the molded body of the present embodiment be used as a coil bobbin.

Coil bobbins, which are a preferred application, will be described below.

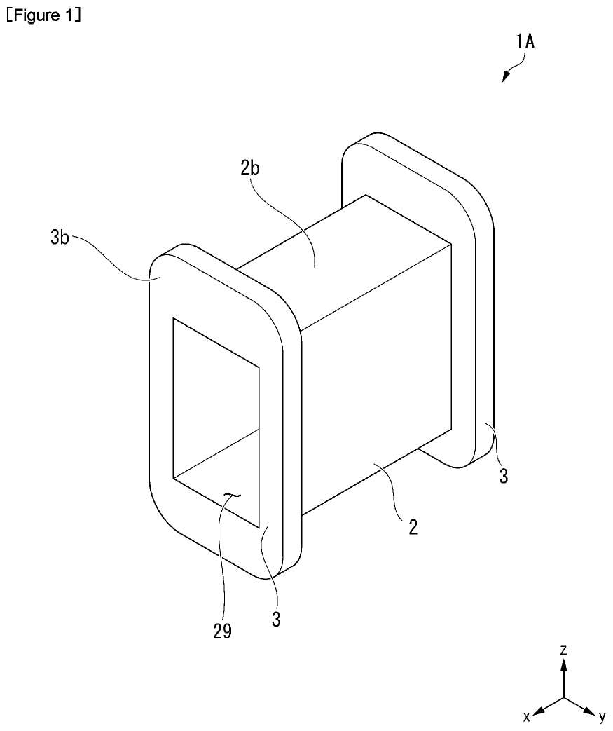

FIG. 1 is a schematic view illustrating a coil bobbin of the present embodiment. As shown in the FIGURE, coil bobbin 1A has a main body 2 and a pair of flanges 3.

In the following explanation, an x-y-z Cartesian coordinate system will be established and a positional relationship of the respective members will be described referring to the x-y-z Cartesian coordinate system. The direction of extension of the main body 2 is defined as the x-axis direction, the direction perpendicular to the x-axis direction in the horizontal plane is defined as the y-axis direction, and the direction perpendicular to (or vertical to) each of the x-axis direction and the y-axis direction is defined as the z-axis direction.

The main body 2 is a cylindrical member. The main body 2 has a shaft hole 29 piercing through the main body 2 in the direction of the x-axis. Winding is wound on the outer surface 2b of the main body 2 in the circumferential direction of the main body 2. The winding wound on the outer surface 2b forms coil.

The flange 3 is provided on both ends of the main body 2 in the direction of extension of the shaft hole 29. The flange 3 is in the form of a ring extending in the direction of the y-z plane. The flange 3 may have a through hole for inserting winding.

The coil bobbin such as coil bobbin 1A described above, which is an electric and electronic part, is used as the core of a coil prepared by winding winding. The temperature of the coil wound on the bobbin is easily increased in the environment of use, or when heated by conduction, and thus the molded body of the present embodiment, which is highly thermally stable, is useful as a coil bobbin.

Since the molded body of the present embodiment illustrated above uses the resin composition described above, the shape of pellets made from the resin composition is less likely to be uneven, and variation is reduced when the pellets are introduced into a molding machine, plasticized and weighed, and thus defects are less likely to occur.

### EXAMPLES

Hereinafter the present invention will be described in more detail with reference to Examples, but the present invention is not limited to the following Examples.

[Measurement of Flow Starting Temperature of Liquid Crystalline Polymer]

The flow starting temperature of the liquid crystalline polymer was measured using an apparatus for evaluating flow properties (product name “Flow Tester CFT-500 Model” made by Shimadzu Corporation).

The temperature at which the liquid crystalline polymer has a melt viscosity of 4,800 Pa·s (48,000 poise) when about 2 g of a sample was placed in a capillary rheometer to which a dice with an inner diameter of 1 mm and a length of 10 mm was attached and the liquid crystalline polymer was extruded through the nozzle at a load of 9.8 MPa (100 kgf/cm²) and a temperature increasing rate of 4° C./minute was defined as the flow starting temperature. The results are shown in Table 1 as “flow starting temperature (° C.)”.

[Production Example of Liquid Crystalline Polymer (Resin A)]

Into a reactor equipped with a stirrer, a torque meter, a nitrogen gas introduction tube, a thermometer and a reflux condenser were added 994.5 g (7.2 moles) of p-hydroxybenzoic acid, 446.9 g (2.4 moles) of 4,4′-dihydroxybiphenyl, 365.4 g (2.2 moles) of terephthalic acid, 33.2 g (0.2 mole) of isophthalic acid, 1347.6 g (13.2 moles) of acetic anhydride and 0.194 g of 1-methylimidazole, which was a catalyst. The mixture was stirred at room temperature for 15 minutes and the gas in the reactor was thoroughly replaced with nitrogen, and then the mixture was heated with stirring. When the inner temperature reached 145° C., the mixture was stirred for 1 hour while keeping the temperature.

Subsequently, while distilling off acetic acid which was distillated as a by-product and unreacted acid anhydride, the mixture was heated to 320° C. for over 2 hours and 50 minutes, and the reaction was considered as completed when the torque was recognized to increase to give a prepolymer. The flow starting temperature of the prepolymer was 263° C.

The resulting prepolymer was cooled to room temperature (25° C.) and ground by a coarse grinder to give powder (particle size about 0.1 to 1 mm) of liquid crystalline polymer (liquid crystal polyester). Then, under nitrogen atmosphere, the temperature was increased from room temperature (25° C.) to 250° C. over 1 hour, from 250° C. to 300° C. over 5 hours, and kept at 300° C. for 3 hours to allow polymerization reaction to proceed in solid phase. The resulting liquid crystalline polymer (liquid crystal polyester: resin A) had a flow starting temperature of 361° C.

For the ratio of the respective repeating units of resin A calculated from the charged amount of raw material monomers, the ratio of the repeating unit (u1) in which Ar¹ was a p-phenylene group (i.e., a repeating unit derived from p-hydroxybenzoic acid) was 60% by mole, the ratio of the repeating unit (u2) in which Are was a p-phenylene group (i.e., a repeating unit derived from terephthalic acid) is 18% by mole, the ratio of the repeating unit (u2) in which Are is an m-phenylene group (i.e., a repeating unit derived from isophthalic acid) was 2% by mole and the ratio of the repeating unit (u3) in which Ara was a 4,4′-biphenylylene group and X and Y are an oxygen atom (i.e., a repeating unit derived from 4,4′-dihydroxybiphenyl) was 20% by mole based on the total amount of the repeating units.

[Production Example of Liquid Crystalline Polymer (Resin B)]

Into a reactor equipped with a stirrer, a torque meter, a nitrogen gas introduction tube, a thermometer and a reflux condenser were added 994.5 g (7.2 moles) of p-hydroxybenzoic acid, 446.9 g (2.4 moles) of 4,4′-dihydroxybiphenyl, 299.0 g (1.8 moles) of terephthalic acid, 99.7 g (0.6 mole) of isophthalic acid and 1347.6 g (13.2 moles) of acetic anhydride. The gas in the reactor was replaced with nitrogen gas and then 0.18 g of 1-methylimidazole was added thereto. While stirring under nitrogen gas stream, the temperature was increased from room temperature to 150° C. over 30 minutes, and the mixture was refluxed at 150° C. for 30 minutes.

Subsequently, while distilling off acetic acid which was distillated as a by-product and unreacted acid anhydride, the mixture was heated to from 150° C. to 320° C. over 2 hours and 50 minutes. When the torque was recognized to increase, the content was removed from the reactor and cooled to room temperature to give a solid prepolymer.

Next, the prepolymer was ground by a grinder, and the resulting ground product was heated from room temperature to 250° C. over 1 hour, from 250° C. to 295° C. over 5 hours, and kept at 295° C. for 3 hours under nitrogen atmosphere to perform solid phase polymerization reaction. The resulting product of the solid phase polymerization was cooled to room temperature to give liquid crystal polyester (L3) in the form of powder. The resulting liquid crystalline polymer (liquid crystal polyester: resin B) had a flow starting temperature of 327° C.

For the ratio of the respective repeating units of resin B calculated from the charged amount of raw material monomers, the ratio of the repeating unit (u1) in which Ar¹ was a p-phenylene group (i.e., a repeating unit derived from p-hydroxybenzoic acid) was 60% by mole, the ratio of the repeating unit (u2) in which Ar² was a p-phenylene group (i.e., a repeating unit derived from terephthalic acid) was 15% by mole, the ratio of the repeating unit (u2) in which Ar² is an m-phenylene group (i.e., a repeating unit derived from isophthalic acid) was 5% by mole and the ratio of the repeating unit (u3) in which Ara was a 4,4′-biphenylylene group and X and Y are an oxygen atom (i.e., a repeating unit derived from 4,4′-dihydroxybiphenyl) was 20% by mole based on the total amount of the repeating units.

[Production Example of Fluororesin]

<Production Example of Resin F1>

A stainless steel autoclave with a capacity of 6 L equipped with two stainless steel flat stirring blade and a jacket for temperature control was charged with 2,760 g of deionized water, and the autoclave was sealed. Nitrogen gas was injected thereinto with pressure and the autoclave was deaerated several times to remove oxygen existing in the system. Then 1.8 g of ethane was injected thereinto as a chain transfer with tetrafluoroethylene (TFE) and the pressure in the tank was set to 0.10 MPa. The temperature in the tank was increased while stirring at 700 rpm, and when the temperature in the tank reached 85° C., TFE was injected thereinto again to adjust the pressure in the tank to 0.80 MPa.

An aqueous solution prepared by dissolving 700 mg of disuccinic acid peroxide (DSP) in 20 g of deionized water and an aqueous solution prepared by dissolving 700 mg of ammonium persulfate (APS) in 20 g of deionized water were injected into the tank as a polymerization initiator with TFE. Since the pressure in the tank decreased due to decomposition of the polymerization initiator, TFE was continuously supplied thereto to keep the pressure in the tank at 0.80±0.05 MPa. During the polymerization reaction, the temperature in the tank was adjusted to 85±1° C. and the number of revolutions for stirring was controlled to 350 rpm.

Next, when the amount of TFE consumed was 175 g, the number of revolutions of stirring was changed to 700 rpm, and the polymerization reaction was performed until another 525 g of TFE was consumed.

Stirring was stopped when the total amount of TFE consumed was 700 g, and the tank was depressurized. The fluororesin in the wet condition on the surface of the liquid and in the liquid after polymerization was washed with deionized water and then filtered. The fluororesin filtered was dried using a hot air circulation dryer at 160° C. for 18 hours to give a fluororesin (resin F1).

<Production Example of Resin F2>

A stainless steel autoclave with a capacity of 36 L equipped with a stainless steel stirring blade was charged with 21.8 kg of deionized water, 50 g of ammonium carbonate buffer and 45 g of a mixture of ammonium perfluoroalkyl(C₄ to C₁₆)ethane sulfonate (average CO. The autoclave was closed and evacuated, and then tetrafluoroethylene (TFE) was blown thereinto three times and the autoclave was evacuated again. Ethane was introduced into the autoclave until the pressure increased to 16.9 kPa, and then 98 mL of perfluoro(propylvinyl ether) (PPVE) and 350 mL of Freon (registered trademark) F-113 (CCl₂FCClF₂) were injected into the autoclave. The autoclave was pressurized to 2.1 MPa using TFE, and simultaneously a solution prepared by dissolving 1.5 g of ammonium persulfate (APS) in 500 mL of deionized water was introduced into the autoclave by a pump. After the start of polymerization (the pressure dropped 0.07 MPa) additional PPVE and a solution prepared by dissolving 1.2 g of APS in 1,000 mL of deionized water were added to the residue of polymerization in the autoclave by a pump at a ratio of 1.10 mL/min and 10 mL/min, respectively. The number of revolutions of the stirring blade was adjusted so as to control the reaction so that the amount of additional TFE necessary to constantly maintain the pressure at 2.2 MPa was 50 g per minute. After adding 7 kg of TFE from the start of the reaction, supply of TFE and PPVE and the stirrer were stopped. A solution of initiator (APS) was continuously supplied to the autoclave by the pump until unreacted matters were discharged from the autoclave. The polymer coagulated was removed from the autoclave, washed with deionized water and dried at 150° C. to give fluororesin (resin F2).

<Production Example of Resin F3>

A fluororesin (resin F3) was prepared in the same manner as for resin F2 except for changing the amount of injection of perfluoro(propylvinyl ether) (PPVE) and Freon (registered trademark) F-113 (CCl₂FCClF₂) which were injected into the autoclave before the start of the reaction to 45 mL of perfluoro(propylvinyl ether) (PPVE) and 350 mL of Freon (registered trademark) F-113 (CCl₂FCClF₂).

<Production Example of Resin F4>

A fluororesin (resin F4) was prepared in the same manner as for resin F2 except for changing the amount of injection of perfluoro(propylvinyl ether) (PPVE) and Freon (registered trademark) F-113 (CCl₂FCClF₂) which were injected into the autoclave before the start of the reaction to 75 mL of perfluoro(propylvinyl ether) (PPVE) and 350 mL of Freon (registered trademark) F-113 (CCl₂FCClF₂).

<Production Example of Resin F5>

A fluororesin (resin F5) was prepared in the same manner as for resin F2 except for changing the amount of injection of perfluoro(propylvinyl ether) (PPVE) and Freon (registered trademark) F-113 (CCl₂FCClF₂) which were injected into the autoclave before the start of the reaction to 165 mL of perfluoro(propylvinyl ether) (PPVE) and 345 mL of Freon (registered trademark) F-113 (CCl₂FCClF₂).

[Evaluation of Properties of Fluororesin]

The CF₃ groups content, the decomposition starting temperature of resin and the number average molecular weight (Mn) of the resins F1 to F5 prepared in Production Examples above were measured by the methods described below. The results are shown in Table 1.

[Measurement of Content of CF₃ Group]:

The CF₃ groups content relative to the CF₂ groups content in resins F1 to F5 was calculated as an area percentage from a peak area ICF₃ corresponding to the CF₃ group and a peak area ICF₂ corresponding to the CF₂ group measured by ¹⁹F solid-state NMR, and was determined by the following formula (f1):

CF₃ groups content (%)={(ICF₃)/3/(ICF₂)/2}×100 (f1)

¹⁹F solid-state NMR measurement for calculating the CF₃ groups content was performed by a single pulse method. Conditions of the measurement are as follows.
Measurement apparatus: PS400WB (Varian)
Strength of static magnetic field: 9.4 Tesla
(Resonance frequency: 400 MHz (1H))
Magic angle spinning: 35 kHz (35,000 revolutions per second)
Repetition time: 15 s
Cumulative number: 128 times
Temperature: 26° C.
Chemical shift reference material: hexafluorobenzene

[Measurement of Decomposition Starting Temperature of Resin]

An aluminum cell was filled with 20 mg each of resins F1 to F5. Next, the temperature at which the ratio of weight reduction was 0.1% when the fluororesin was heated from 25° C. (room temperature) to 800° C. under conditions of heating of 10° C./minute at a flow rate of nitrogen gas of 50 mL/minute was measured using a thermogravimetry measurement apparatus (product name: TGA-50 made by Shimadzu Corporation). The temperature was defined as the decomposition starting temperature of resin.

[Measurement of Number Average Molecular Weight (Mn)]

The number average molecular weight (Mn) of resins F1 to F5 was determined by the method disclosed in J. Appl. Polym. Sci. 1973, 17, 3253. The amount of heat of crystallization (J/g) was determined by using a differential scanning calorimeter (product name: DSC-50 made by Shimadzu Corporation), and converted into the amount of heat of crystallization (ΔHc: cal/g), and the number average molecular weight (Mn) was calculated by the following equation (m-1):

Number average molecular weight (Mn)=2.1×10¹⁰ΔHc^{-5.16} (m-1)

TABLE 1

| | Resin F1 | Resin F2 | Resin F3 | Resin F4 | Resin F5 |
|---|---|---|---|---|---|
| CF₃ group content | 0.1960 | 0.0637 | 0.0600 | 0.0600 | Less than |
| (%) | | | | | detection limit |
| Decomposition starting | 472 | 481 | 474 | 478 | 490 |
| temperature of resin | | | | | |
| (° C.) | | | | | |
| Amount of heat of | 129.7 | 58.6 | 64.6 | 64.8 | 20.8 |
| crystallization | | | | | |
| (J/g) | | | | | |
| Amount of heat of | 31.0 | 14.0 | 15.4 | 15.5 | 5.0 |
| crystallization | | | | | |
| (cal/g) | | | | | |
| Number average | 424 | 25479 | 15449 | 15204 | 5338290 |
| molecular weight | | | | | |
| (Mn) | | | | | |

[Production Example 1 of Resin Composition]

### Examples 1 to 4, Comparative Example 1

The resin compositions (pellets) of the respective Examples were prepared by granulating liquid crystalline polymer, glass fiber, fluororesin and pigment according to the blending ratio shown in the following Table 2 by using a twin screw extruder (PCM-30 made by Ikegai Co., Ltd.) at a cylinder temperature of 340° C.

[Evaluation of Occurrence of Die Swell 1]

In Production Examples of the resin compositions described above, the diameter of the die hole of the twin screw extruder and the diameter of a cross-section of the resin composition (pellets) of the respective Examples extruded through the die hole were visually observed to evaluate occurrence of die swell according to the following criteria.

A: The diameter of the die hole and the diameter of the cross-section of the pellet are substantially the same.

B: The diameter of the cross-section of the pellet is larger than the diameter of the die hole, causing poor cutting in the subsequent step of cutting pellets.

TABLE 2

| | | | | | Compar- |
|---|---|---|---|---|---|
| | | | | | ative |
| | Exam- | Exam- | Exam- | Exam- | Exam- |
| | ple 1 | ple 2 | ple 3 | ple 4 | ple 1 |
| Liquid | Resin A | Resin A | Resin A | Resin A | Resin A |
| crystalline | [59.00] | [59.00] | [59.00] | [59.00] | [59.00] |
| polymer | | | | | |
| Glass fiber | G1 | G1 | G1 | G1 | G1 |
| | [39.33] | [39.33] | [39.33] | [39.33] | [39.33] |
| Fluororesin | Resin F1 | Resin F2 | Resin F3 | Resin F4 | Resin F5 |
| | [0.69] | [0.69] | [0.69] | [0.69] | [0.69] |
| Pigment | M1 | M1 | M1 | M1 | M1 |
| | [0.98] | [0.98] | [0.98] | [0.98] | [0.98] |
| Occurrence | A | A | A | A | B |
| of die swell | | | | | |

In Table 2, abbreviations mean the following, respectively. The numerical figures in [ ] means its content (% by mass).

Resin A: liquid crystalline polymer (liquid crystal polyester; resin A) prepared by the above method.

G1: glass fiber (product name: Milled Fiber EFH75-01, made by Central Glass Co., Ltd., fiber diameter 11 μm, fiber length 75 μm).

Resins F1 to F5: fluororesin prepared by the respective methods described above.

M1: carbon black (product name: #45LB made by Mitsubishi Chemical Corporation, primary particle size 24 nm, specific surface area 125 m²/g, amount of oil absorption 45 mL/100 g).

As shown in Table 2, the resin compositions of Examples 1 to 4, which contain resins F1 to F4 having a peak area percentage of the CF₃ groups content of 0.05% or more, have a better effect of suppressing occurrence of die swell than the resin composition of Comparative Example 1.

[Evaluation of Thermal Stability]

<Measurement of Ratio of Change of b*>

A 64-mm wide, 64-mm long, and 3-mm thick test piece was prepared by injection molding, using the resin compositions of Examples. For the specimen prepared, b* immediately after preparing the specimen and b* after heating the specimen at 300° C. for 2 hours were measured, respectively, using a spectrophotometer (product name: CM-3600d made by Konika Minolta, Inc.). The ratios of change are shown in Table 3.

TABLE 3

| | Example 1 | Example 2 | Example 3 | Example 4 |
|---|---|---|---|---|
| Ratio of change | 11.9% | 9.8% | 3.3% | 1.2% |
| of b* | | | | |

As shown in Table 3, the molded bodies prepared using the resin composition of Examples 1 to 4, which include liquid crystalline polymer and resins F1 to F4 having a peak area percentage of the CF₃ groups content of 0.05% or more, had a low ratio of change of b*, and yellowing was suppressed. This indicates that the molded bodies prepared using the resin composition of Examples 1 to 4 have high thermal stability.

Furthermore, of Examples, the molded bodies prepared using the resin composition of Examples 2 to 4 containing resins F2 to F4, in particular, had a small ratio of change of b*, and yellowing was suppressed.

As shown in Tables 2 and 3, the resin compositions of Examples had high thermal stability and a good effect of suppressing occurrence of die swell.

[Production Example 2 of Resin Composition]

### Examples 5 to 8

The resin composition (pellets) of the respective Examples was prepared by granulating liquid crystalline polymer, flaky filler, the fluororesin and pigment according to the blending ratio shown in the following Table 4 by using a twin screw extruder (PCM-30 made by Ikegai Co., Ltd.) at a cylinder temperature of 340° C.

[Evaluation of Occurrence of Die Swell 2]

The occurrence of die swell in the resin composition of Examples 5 to 8 was evaluated in the same manner as in the above [Evaluation of occurrence of die swell 1].

TABLE 4

| | Example 5 | Example 6 | Example 7 | Example 8 |
|---|---|---|---|---|
| Liquid crystalline | Resin B | Resin B | Resin B | Resin B |
| polymer | [52.00] | [52.00] | [52.00] | [52.00] |
| Plate filler | T1 | T1 | T1 | T1 |
| | [40.90] | [40.90] | [40.90] | [40.90] |
| Fluororesin | Resin F1 | Resin F2 | Resin F3 | Resin F4 |
| | [0.70] | [0.70] | [0.70] | [0.70] |
| Pigment | M2 | M2 | M2 | M2 |
| | [1.90] | [1.90] | [1.90] | [1.90] |
| | M3 | M3 | M3 | M3 |
| | [0.80] | [0.80] | [0.80] | [0.80] |
| | M4 | M4 | M4 | M4 |
| | [3.70] | [3.70] | [3.70] | [3.70] |
| Occurrence of | A | A | A | A |
| die swell | | | | |

In Table 4, abbreviations mean the following, respectively. The numerical figures in [ ] means its content (% by mass).

Resin B: liquid crystalline polymer (liquid crystal polyester, resin B) prepared by the above method.

T1: Talc (Product name: MS-KY made by Nippon Talc Co., Ltd., median diameter (D50) 21 μm).

Resins F1 to F4: fluororesin prepared by the respective methods described above.

M2: titanium yellow (Product name: TY-70S, made by Ishihara Sangyo Kaisha, Ltd., average particle size 1.00 μm)

M3: carbon black (product name: BP4350 made by Cabot Corporation, amount of oil absorption 66 to 77 mL/100 g).

M4: titanium oxide (Product name: CR-60 made by Ishihara Sangyo Kaisha, Ltd., average particle size 0.21 μm).

As shown in Table 4, the resin compositions of Examples 5 to 8 also had a good effect of suppressing occurrence of die swell as the resin compositions of Examples 1 to 4 described above had.

Preferred Examples of the present invention have been described above, but the present invention is not limited to those Examples. Addition, omission, substitution of a configuration, and other modifications of a configuration are possible unless they depart from the object of the present invention. The present invention is not limited to the above illustration and is limited only to the scope of the attached claims.

### REFERENCE SIGNS LIST

1A Coil bobbin
2 Main body
3 Flange

1. A resin composition comprising a liquid crystalline polymer and a fluororesin, wherein the fluororesin has a peak area percentage of a CF₃ groups content relative to a CF₂ groups content in the fluororesin of 0.05% or more, as determined by the following [Method for measuring CF₃ groups content]:
[Method for measuring CF₃ groups content]:
the CF₃ groups content relative to the CF₂ groups content in the fluororesin is calculated as an area percentage from a peak area ICF₃ corresponding to the CF₃ groups and a peak area ICF₂ corresponding to the CF₂ groups measured by ¹⁹F solid-state NMR, and is determined by the following formula (f1):
CF₃ groups content (%)={(ICF₃/3)/(ICF₂/2)}×100 (f1).

2. The resin composition according to claim 1, further comprising a glass fiber.

3. The resin composition according to claim 1, further comprising a plate filler.

4. The resin composition according to claim 1, wherein the fluororesin has an decomposition starting temperature of resin of 473° C. or higher.

5. A molded body prepared by using the resin composition according to claim 1.
